(19) United States
(12) Patent Application Publication
(10) Pub. No.: US 2025/0055204 A1
(43) Pub. Date: Feb. 13, 2025

(54) RADIATOR ASSEMBLY FOR BASE STATION ANTENNA AND BASE STATION ANTENNA

(71) Applicant: Outdoor Wireless Networks LLC, Claremont, NC (US)

(72) Inventors: YueMin Li, Suzhou (CN); Long Shan, Claremont (CN); Junfeng Yu, Suzhou (CN); Yabing Liu, Suzhou (CN); GuoLong Xu, Suzhou (CN)

(21) Appl. No.: 18/927,213

(22) Filed: Oct. 25, 2024

Related U.S. Application Data
(62) Division of application No. 17/667,897, filed on Feb. 9, 2022, now Pat. No. 12,160,045.
Application No. 17/667,897 is a continuation of application No. 16/671,529, filed on Nov. 1, 2019, now Pat. No. 11,283,194.

(30) Foreign Application Priority Data
Dec. 10, 2018 (CN) 201811500081.6

(51) Int. Cl. H01Q 21/26; H01Q 1/24; H01Q 1/42; H01Q 5/42; H01Q 5/48; H01Q 15/14; H01Q 21/00; H01Q 21/06; H01Q 21/28

(52) U.S. Cl. CPC H01Q 21/26; H01Q 1/246; H01Q 1/42; H01Q 5/42; H01Q 5/48; H01Q 15/14; H01Q 21/0006; H01Q 21/062; H01Q 21/28

(57) ABSTRACT

The present disclosure is directed to a radiator assembly for a base station antenna. The radiator assembly includes two dipoles arranged in a cross-over manner, each dipole includes two dipole arms having respective radiating surfaces. The radiator assembly further includes two feeding lines, each feeding line being associated with a respective one of the dipoles. The radiator assembly further includes an arm holder including a support structure for supporting the dipole arms and at least one feeding line holder configured to support at least one of the two feeding lines.

### CROSS-REFERENCE TO RELATED APPLICATION

The present application is a divisional of U.S. patent application Ser. No. 17/667,897, filed Feb. 9, 2022, which is continuation of U.S. patent application Ser. No. 16/671,529, filed Nov. 1, 2019, now U.S. Pat. No. 11,283,194 issued Mar. 22, 2022, which claims priority from and the benefit of Chinese Patent Application No. 201811500081.6, filed Dec. 10, 2018, the entire contents of which are incorporated herein by reference in their entireties.

### FIELD

The present invention relates to the field of communication, and more specifically, the present invention relates to a radiator assembly for a base station antenna and a base station antenna comprising the same.

### BACKGROUND

A mobile communication network includes a large number of base stations. Each base station includes one or more base station antennas that receive and transmit communication signals. The base station antennas may include many radiator assemblies, which are also referred to as radiating elements or antenna elements. The cost of a single radiator assembly has a significant impact on the cost of the entire base station antenna. Miniaturization and cost reduction of the radiator assembly are desirable.

PCT patent application WO2016081036A1 discloses a base station antenna comprising a low frequency band radiator array and a high frequency band radiator array, where the individual dipole arms of each low frequency band radiator assembly are implemented on respective printed circuit boards.

### SUMMARY

According to an aspect of the present invention, a radiator assembly for a base station antenna is provided. The radiator assembly includes two dipoles arranged in a cross-over manner, each dipole includes two dipole arms having respective radiating surfaces. The radiator assembly further includes two feeding lines, each feeding line being associated with a respective one of the dipoles. The radiator assembly further includes an arm holder including a support structure for supporting the dipole arms and at least one feeding line holder configured to support at least one of the two feeding lines.

According to another aspect of the present invention, a radiator assembly for a base station antenna is provided. The radiator assembly includes two dipoles arranged in a cross-over manner, each dipole includes two dipole arms having respective radiating surfaces and a leg projecting from the radiating surface. The radiator assembly further includes a support structure having a central recess, the support structure being configured to support the dipole arms, and a feeding line arrangement positioned within the central recess of the support structure. The leg of each dipole arm is received by the central recess and rests against a respective inner wall of the central recess.

According to another aspect of the present invention, a radiator assembly for a base station antenna is provided. The radiator assembly includes two dipoles arranged in a cross-over manner, each dipole includes two dipole arms having respective radiating surfaces and a leg projecting from the radiating surface. The radiator assembly further includes a first feeding line and a second feeding line, each feeding line being associated with a respective one of the dipoles, a support structure having a central recess, the support structure being configured to support the dipole arms, and a feeding line arrangement positioned within the central recess of the support structure and configured to support the two feeding lines. The feeding line arrangement includes a plurality of snap-fit elements configured to form a snap-fit connection with the feeding lines.

It is also to be noted here that, various technical features mentioned in the present application, even if they are recited in different paragraphs of the description or described in different embodiments, may be combined with one another randomly, as long as these combinations are technically feasible. All of these combinations are the technical contents recited in the present application

### BRIEF DESCRIPTION OF THE DRAWINGS

FIG. 1 is a perspective view of a radiator assembly according to an embodiment of the present invention.

FIG. 2 is a series of perspective views of various of the constituent parts of the radiator assembly according to FIG. 1.

FIG. 3 is an exploded view of the feeding line arrangement of the radiator assembly of FIGS. 1 and 2.

FIG. 4a is a side view of the radiator assembly of FIGS. 1-3.

FIG. 4b is a partial perspective view of the radiator assembly cut away along the section line A-A of FIG. 4a.

FIG. 4c is a partial enlarged bottom perspective view of the radiator assembly of FIGS. 1-3.

FIG. 5 is a schematic front view of a base station antenna according to an embodiment of the present invention.

FIGS. 6 and 7 are perspective views of radiator assemblies according to further embodiments of the present invention.

FIG. 8 is a front view of an arm holder of the radiator assembly of FIG. 7.

FIG. 9 is a perspective view of the radiating surfaces of four dipole arms according to an embodiment of the present invention.

### DETAILED DESCRIPTION

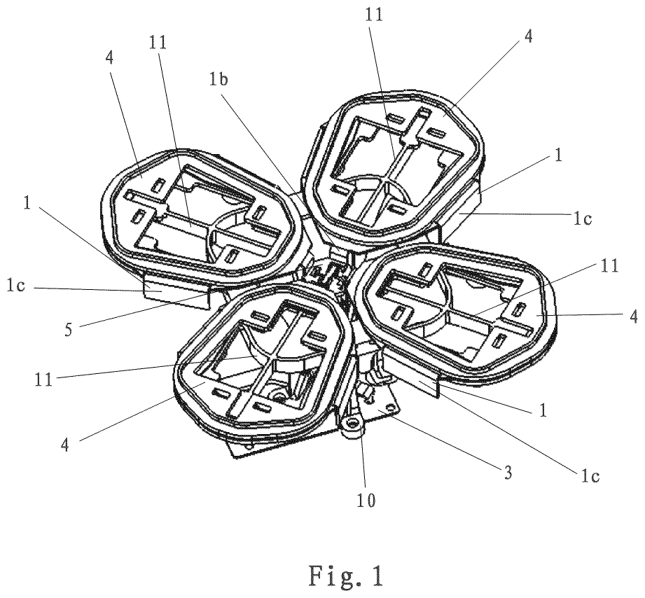

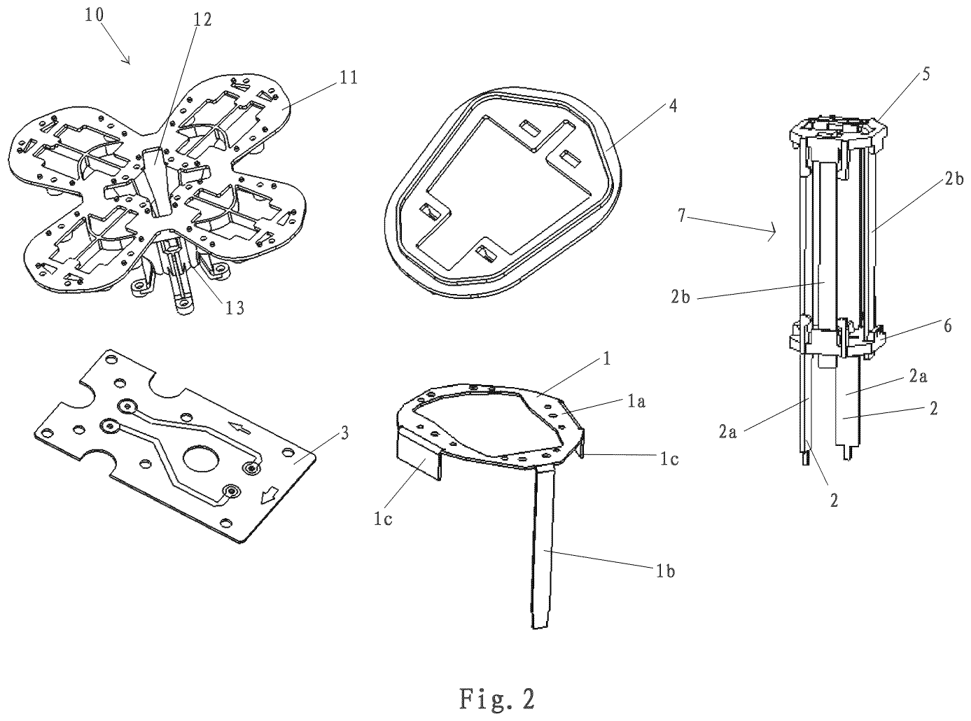

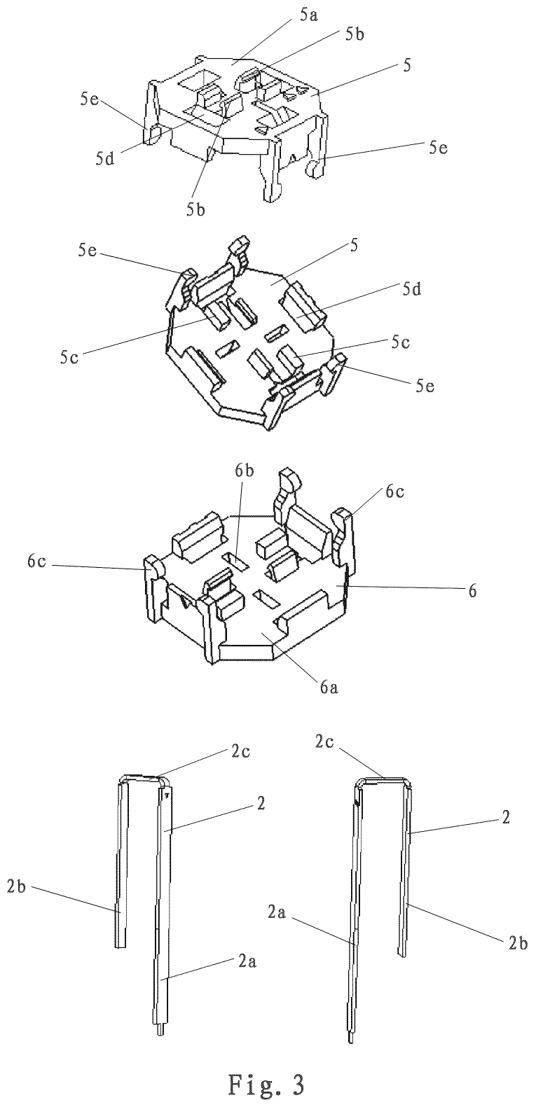

FIG. 1 is a perspective view of a radiator assembly according to an embodiment of the present invention. FIG. 2 is a series of perspective views of various of the constituent parts of the radiator assembly, and FIG. 3 is an exploded view of the feeding line arrangement of the radiator assembly, wherein the first feeding line holder 5 is depicted in FIG. 3 from two different perspectives. The radiator assembly is suitable for use as a low frequency band radiator assembly, especially applicable for a frequency range of 694 to 960 MHz.

The radiator assembly may comprise an arm holder 10 which may support four dipole arms 1. For the sake of simplicity, only one of the dipole arms 1 is depicted in FIG. 2, and the other three dipole arms 1 may be constructed identically or similarly. Every two dipole arms 1 constitute a dipole, and two dipoles are arranged in a cross-over manner.

As can be seen in FIG. 2, the arm holder 10 includes a foot 13, a central recess 12 and four arm supports 11 that surround the central recess 12. The foot 13 may be configured to secure the arm holder 10 to another element of the base station antenna. For example, the foot 13 may be used to secure the arm holder 10 onto a substrate or a reflector plate by screws. The central recess 12 may be configured to receive the feeding line arrangement 7. Each arm support 11 may be configured to support a respective one of the dipole arms 1. The arm holder 10 may be made of a non-conductive material, for example plastic.

Each dipole arms 1 may be integrally formed from sheet metal, for example, formed by stamping, and a single dipole arm 1 includes a radiating surface 1a and a leg 1b projecting rearwardly from the radiating surface at an angle with the radiating surface and especially substantially perpendicular to the radiating surface. The leg 1b is electrically grounded. For example, the leg 1b may contact a grounding layer of a feeding plate 3 or a reflector plate, or may be capacitively coupled with the grounding layer of the feeding plate 3 or the reflector plate so as to realize the grounding. For example, the dipole arm 1 may have a tin plating layer in its entirety or only in the region of its leg 1b in order to be welded with the grounding layer of the feeding plate. Alternatively, it is also possible that the end of the leg 1b is provided with a PEM stud with a tin plating layer, so that it is not necessary to apply a tin plating layer to the dipole arm 1. The feeding plate 3 may be constructed as a printed circuit board and may or may not be a constituent part of the radiator assembly. Alternatively, the feeding may also be realized by coaxial cables or other radio frequency transmission line structures.

Each dipole arm 1 may be inserted into the central recess 12 so that their legs 1b, for example, may rest against the inner wall of the central recess 12. The radiating surfaces 1a of the dipole arms 1 may be supported on the respective arm supports 11 of the arm holder 10. The arm supports 11 may have a contour substantially identical to the respective radiating surface 1a in some embodiments. In an example embodiment, each radiating surface 1a may have a snap-fit element for establishing a snap-fit connection with a respective one of the arm supports 11. In other embodiments, each radiating surface 1a may be fastened onto a respective one of the arm supports 11 by screws or using adhesives. In the embodiments shown in FIGS. 1 and 2, each dipole arm 1 is provided with a cover 4, such that the radiating surface 1a of the dipole arm 1 is clamped between the arm support 11 and the cover 4, where the cover 4 may be detachably connected, for example snap-fittedly connected or non-detachably connected to its corresponding arm support 11. The four covers 4 may be implemented as four separate structures or as a single cover in example embodiments.

The radiating surface 1a of each dipole arm 1 may be constructed to be substantially free of openings. Alternatively, the radiating surface 1a may also have one or more openings in order to, for example, reduce material costs and weight. In the embodiment shown in FIG. 2, the radiating surface 1a has a central opening, and the radiating surface 1a is constructed to be substantially annular.

As shown in FIG. 2, the dipole arm 1 has two rearwardly-extending tabs 1c which extend substantially perpendicularly with respect to the radiating surface 1a, and which have a rectangular contour. The tabs 1c may increase the operating bandwidth of the radiator assembly. The tabs 1c may also have other contour shapes, for example may have a substantially triangular contour. The number of tabs 1c may also be one, three or more in other embodiments. The angle that the tab 1c forms with respect to the radiating surface 1a may be, for example, between 60° and 120°, preferably between 70° and 110°, in particular between 80° and 100°.

The central recess 12 receives a feeding line arrangement 7, which may include two substantially U-shaped feeding lines 2 formed from sheet metal, for example by stamping, and each of the feeding lines 2 respectively includes two legs 2a, 2b and a limb 2c connecting the two legs 2a, 2b. Each U-shaped feeding line 2 may form a hook balun that passes radio frequency signals to and from the two dipole arms 1 of a respective one of the dipoles of the radiator assembly.

The feeding line arrangement 7 may include a first feeding line holder 5, which holds the limbs 2c of the two feeding lines 2 in a spaced-apart relationship. As shown in FIG. 3, the first feeding line holder 5 may include a body 5a having a first (front) side surface, and a second (rear) side that is opposite the first side surface. Two pairs of snap-fit elements 5b are provided on the first side surface, and a through hole 5d is provided beside each respective pair of snap-fit elements 5b. The legs 2a, 2b of one of the two feeding lines 2 passes through the two through holes 5d and is snap-fittedly connected with the two pairs of snap-fit elements 5b by its limb 2c. Two pairs of snap-fit elements 5c are provided on the second side surface, and the other feeding line of the two feeding lines 2 is snap-fittedly connected with the two pairs of snap-fit elements 5c by its limb 2c. The snap-fit elements 5b and the snap-fit elements 5c are arranged in a cross-over manner, particularly arranged substantially perpendicularly to one another.

As shown in FIG. 3, the first feeding line holder 5 may include two pairs of third snap-fit elements 5e that project rearwardly from its body 5a, where each pair of third snap-fit elements is configured to form a snap-fit connection with the leg 1b of a corresponding dipole arm 1. This configuration makes it possible to easily realize predetermined stable relative positions of the legs 2a, 2b of the feeding line 2 with respect to the legs 1b of the respective dipole arms 1.

The feeding line arrangement 7 may include a second feeding line holder 6, which may include a body 6a and four through holes 6b that are formed through the body 6a, where each through hole 6b is configured for passage of one of the legs 2a, 2b of the feeding lines 2, so that it is possible to favorably maintain predetermined stable relative positions between the two feeding lines 2 and between their legs 2a, 2b. The second feeding line holder 6 may include two pairs of snap-fit elements 6c projecting from its body 6a, wherein each pair of snap-fit elements 6c is configured to form a snap-fit connection with the leg 1b of one corresponding dipole arms 1, Thus, it is possible to easily realize predetermined stable relative positions of the legs 2a, 2b of the feeding line 2 and the leg 1b of the respective dipole arm 1.

In the embodiment shown in FIGS. 2 and 3, the feeding line arrangement 7 includes two feeding line holders 5, 6. It is also possible to provide only one single feeding line holder, or it is also possible to provide three or more feeding line holders. In the case of a single feeding line holder, it may be particularly advantageous for the feeding line holder to have holding elements for holding the respective legs 2a, 2b of the two feeding lines 2 and holding elements for holding the legs 1b of the dipole arms 1. The feeding line holder may be made of a non-conductive material, for example plastic.

In the embodiment shown in FIGS. 2 and 3, the arm holder 10 and the two feeding line holders 5, 6 are respectively constructed as separate members. Alternatively, the arm holder 10 and the two feeding line holders 5, 6 may be constructed as one piece, for example integrally made by injection molding. It is also possible that the arm holder 10 and one of the feeding line holders (for example the second feeding line holder 6) are constructed as one piece, while the other of the feeding line holders (for example the first feeding line holder 5) is constructed as a separate member.

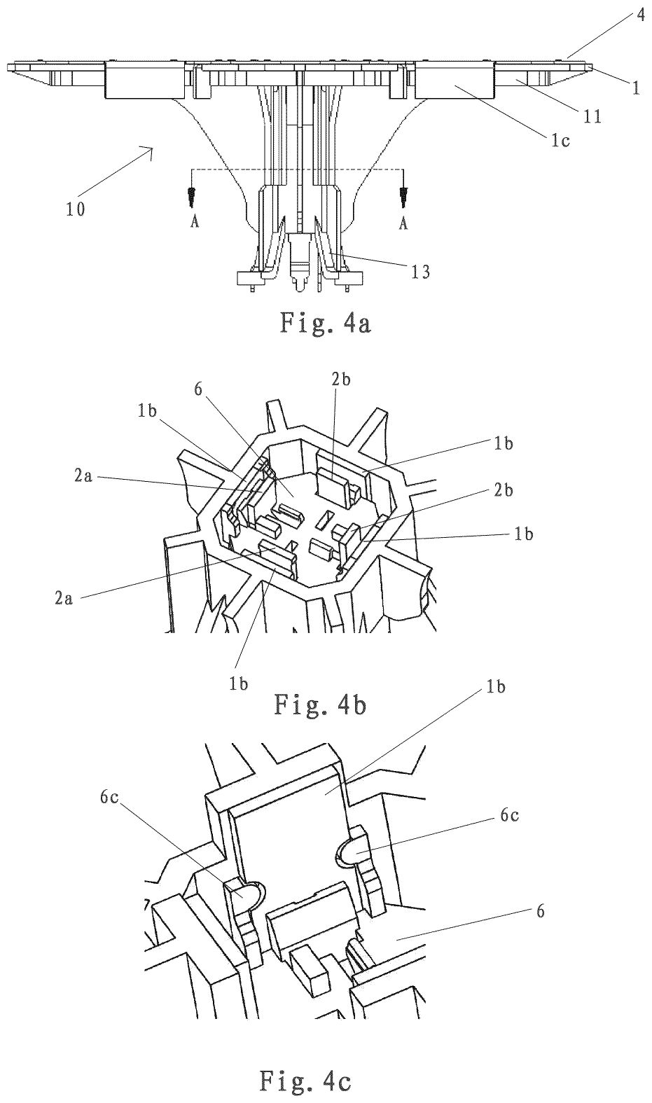

FIG. 4a is a side view of the radiator assembly according to FIGS. 1-3, FIG. 4b is a partial perspective view of the radiator assembly cut away along the section line A-A of FIG. 4a, and FIG. 4c is a partial enlarged bottom view of the radiator assembly.

In FIG. 4b, it can be seen that the second feeding line holder 6 is placed in the central recess 12 of the arm holder 10. The legs 1b of the four dipole arms 1 each rest against the inner wall of the central recess 12, and the two legs 2a, 2b of each feeding line 2 are opposite to and spaced apart from one of the two legs 1b of the two dipole arms 1 of one dipole respectively. FIG. 4c shows a pair of snap-fit elements 6c of the second feeding line holder 6 and a pair of counterpart snap-fit elements of the leg 1b constructed as recesses, thereby a snap-fit connection between the second feeding line holder 6 and the leg 1b can be established, so that the feeding line 2 and the corresponding dipole arm 1 are situated in predetermined stable relative position.

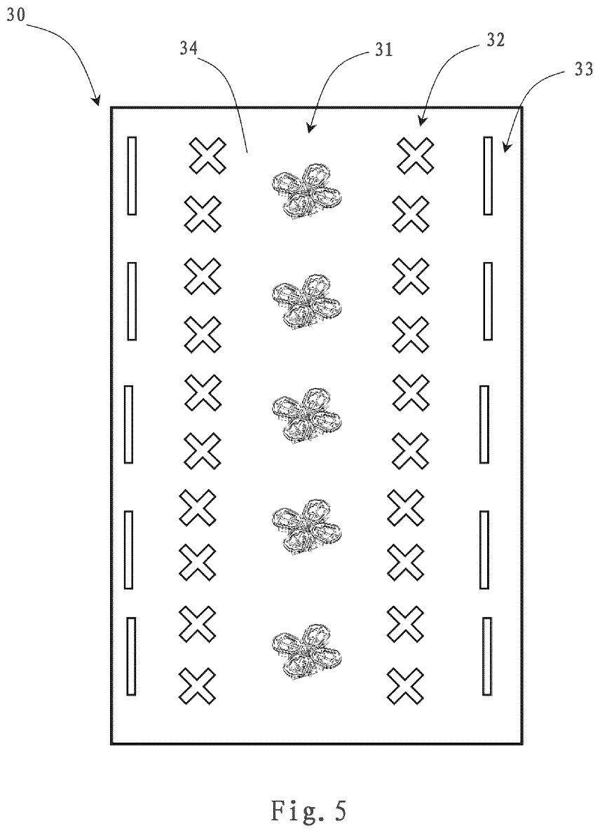

FIG. 5 is a schematic front view of a base station antenna 30 according to an embodiment of the present invention, which is constructed as a dual frequency band base station antenna comprising a substrate or reflector 34, a low frequency band radiator array 31 and a pair of high frequency band radiator arrays 32 placed on the substrate, as well as parasitic element arrays 33. The low frequency band radiator array 31 may include a plurality of radiator assemblies according to the present invention. The low frequency band array 31 may be arranged between the two high frequency band radiator arrays 32. Each high frequency band radiator array 32 may include a plurality of high frequency band radiator assemblies known from the prior art. Each parasitic unit array 33 may include a plurality of parasitic elements known from the prior art. Here, the low frequency band especially refers to the frequency range of 694 to 960 MHz, and the high frequency band especially refers to the frequency range of 1695 to 2690 MHz, although embodiments of the present invention are not limited thereto. When two different frequency bands are concerned, the one may be referred as low frequency band, and the other may be referred as high frequency band.

In other embodiments, the base station antenna 30 may be a single frequency band, for example, including only the low frequency band radiator array 31, or may also include more than two frequency bands. In FIG. 5, the number and arrangement of the low frequency band radiator assemblies, the number and arrangement of the high frequency band radiator assemblies, and the number and arrangement of the parasitic elements are all exemplary.

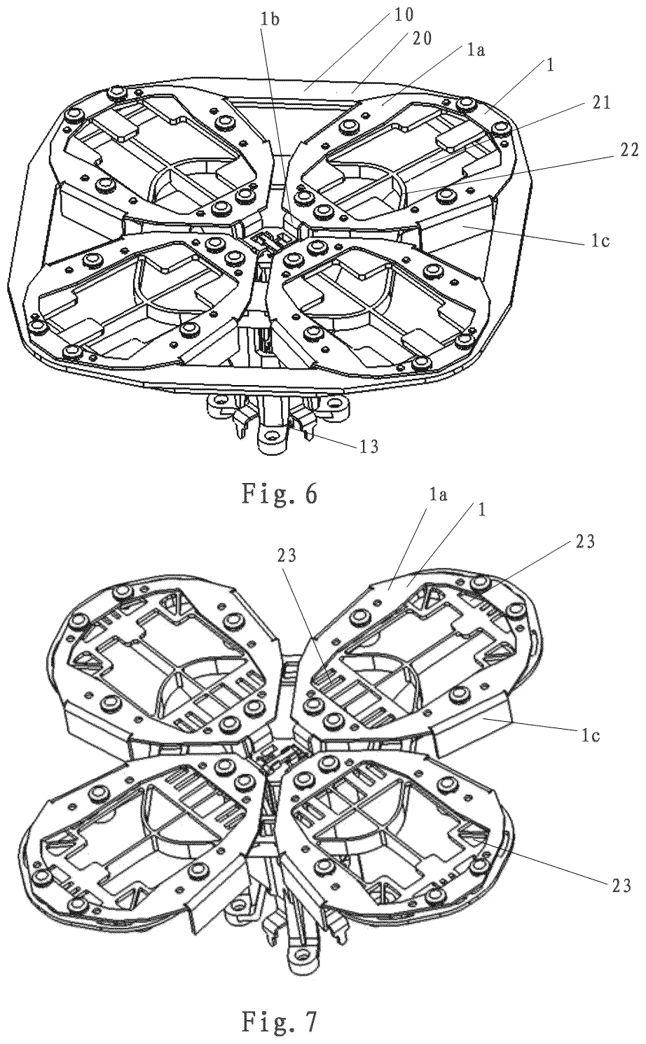

FIG. 6 is a perspective view of a radiator assembly according to another embodiment of the present invention. Here, the dipole arms 1, the feeding lines 2 and the feeding line holders 5, 6 may be constructed identically or similarly to the embodiment according to FIG. 1. The difference from the embodiment according to FIG. 1 lies primarily in the construction of the arm holder 10. In the embodiment according to FIG. 6, the arm holder 10 includes a grid structure for supporting the radiating surfaces 1a of the dipole arms 1, where the grid structure includes an outer ring 20, an inner ring 22 and generally radially extending ribs 21 connecting the inner ring 22 and the outer ring 20 to each other. The radiating surfaces 1a of the dipole arms 1 are supported and fixed on the outer ring 20 and the inner ring 22. Compared to the embodiment according to FIG. 1, the arm holder 10 according to FIG. 6 has a reduced weight. In addition, the effect of the arm holder 10 on the adjacent high frequency band radiator assemblies may be reduced, especially when the high frequency band radiator assemblies are mounted below the radiator assembly according to the present invention.

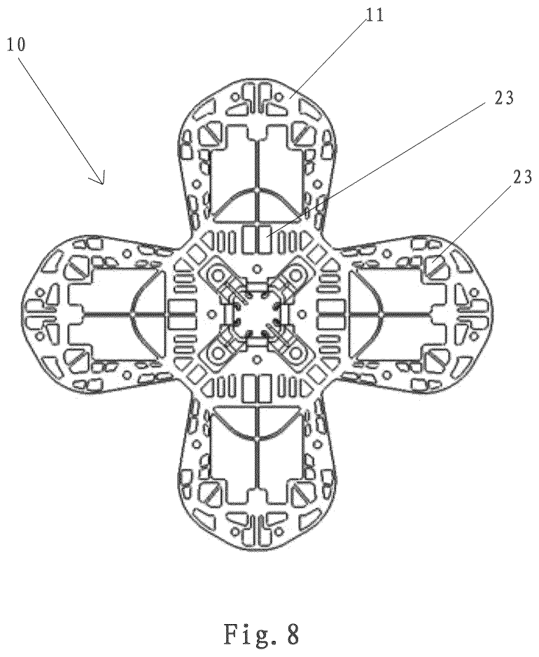

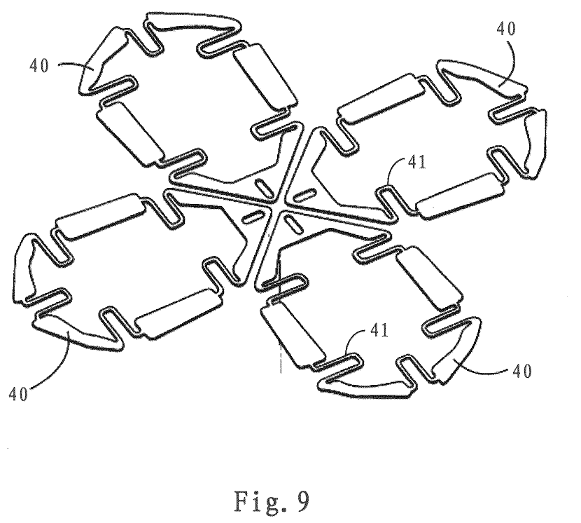

FIG. 7 is a perspective view of a radiator assembly according to another embodiment of the present invention, and FIG. 8 is a top view of an arm holder 10 of the radiator assembly according to FIG. 7. Here, the dipole arms 1, the feeding lines 2 and the feeding line holders 5, 6 may be constructed identically or similarly to the embodiment according to FIG. 1. The difference from the embodiment according to FIG. 1 lies primarily in the construction of the arm holder 10. The arm holder 10 according to FIG. 7 includes many openings 23. Compared to the embodiment according to FIG. 1, the arm holder 10 according to FIG. 7 has a reduced weight. In addition, the effect of the arm holder 10 on the adjacent high frequency band radiator assemblies may be reduced, especially when the high frequency band radiator assemblies are mounted below the radiator assembly according to the present invention.

The radiator assemblies according to FIGS. 6 to 8, in particular the low frequency band radiator assemblies, may be applied in the base station antenna as shown in FIG. 5.

It will also be appreciated that the radiating surface 1a of each dipole arm may be varied from what is shown in the above embodiments. For example, each radiating surface 1a may be formed as first and second spaced-apart conductive segments that together form a generally oval shape or a generally elongated rectangular shape. Distal ends of the first and second conductive segments of each dipole arm may be electrically connected to each other so that each dipole arm each has a closed loop structure. Each of the first and second conductive segments may include a plurality of widened sections and narrowed meandered conductive trace sections that connect adjacent ones of the widened sections. The narrowed meandered conductive trace sections may create a high impedance for currents that are, for example, at frequencies that are approximately twice the highest frequency in the operating frequency range of the low frequency band radiator assembly. The narrowed meandered conductive trace sections may make the low frequency band radiator assemblies according to embodiments of the present invention substantially transparent to radio frequency energy in the high frequency band. As a result, the low frequency band radiator assemblies may have little or no impact on the high frequency band radiator assemblies. FIG. 9 illustrates the radiating surfaces 1a of four dipole arms 1 that are each implemented as widened sections 40 that are coupled together by narrowed meandered conductive trace sections 41. The remaining components of the radiator assembly are omitted and the legs 1b of the dipole arms are not shown in FIG. 9.

Finally, it is to be noted that, the above-described embodiments are merely for understanding the present invention but do not limit the scope of the present invention. For those skilled in the art, amendments may be made on the basis of the above-described embodiments, and these amendments do not depart from the protection scope of the present invention.

What is claimed is:

1. A radiator assembly for a base station antenna, the radiator assembly comprising:
two dipoles arranged in a cross-over manner, each dipole including two dipole arms having respective radiating surfaces;
two feeding lines, each feeding line being associated with a respective one of the dipoles;
an arm holder including a support structure for supporting the dipole arms; and
at least one feeding line holder configured to support at least one of the two feeding lines.

2. The radiator assembly according to claim 1, wherein the arm holder includes a plurality of openings.

3. The radiator assembly according to claim 1, wherein the support structure of the arm holder is a grid structure.

4. The radiator assembly according to claim 1, wherein the support structure includes an outer ring, an inner ring, and generally radiating extending ribs connecting the inner ring and the outer ring.

5. The radiator assembly according to claim 4, wherein the radiating surfaces of the dipole arms are supported and fixed on the outer and inner rings.

6. The radiator assembly according to claim 1, wherein each radiating surface is formed as a first conductive segment spaced-apart from a second conductive segment, the distal ends of the first and second conductive segments of each dipole arm being electrically connected to each other such that each dipole arm has a closed loop structure.

7. The radiator assembly according to claim 6, wherein each of the first and second conductive segments include a plurality of widened sections and narrowed meandered conductive trace sections that connect adjacent widened sections.

8. The radiator assembly according to claim 7, wherein the radiating surfaces of the dipole arms are each implemented as widened sections coupled together via narrowed meandered conductive trace sections.

9. A radiator assembly for a base station antenna, the radiator assembly comprising:
two dipoles arranged in a cross-over manner, each dipole including two dipole arms having respective radiating surfaces and a leg projecting from the radiating surface;
a support structure having a central recess, the support structure configured to support the dipole arms; and
a feeding line arrangement positioned within the central recess of the support structure,
wherein the leg of each dipole arm is received by the central recess and rests against a respective inner wall of the central recess.

10. The radiator assembly according to claim 9, wherein the feeding line arrangement comprises two feeding lines, each feeding line being associated with a respective one of the dipoles.

11. The radiator assembly according to claim 9, wherein the support structure includes four arm holders surrounding the central recess and a foot, the foot is configured to secure the support structure to a substrate or reflector of the base station antenna, and each arm holder is configured to support a respective dipole arm.

12. The radiator assembly according to claim 9, wherein each dipole arm is integrally formed of a sheet of metal, wherein the leg projects from the radiating surface at an angle with the radiating surface and is electrically grounded.

13. The radiator assembly according to claim 9, wherein the support structure includes an outer ring, an inner ring, and generally radiating extending ribs connecting the inner ring and the outer ring.

14. The radiator assembly according to claim 13, wherein the radiating surfaces of the dipole arms are supported and fixed on the outer and inner rings.

15. A radiator assembly for a base station antenna, the radiator assembly comprising:
two dipoles arranged in a cross-over manner, each dipole including two dipole arms having respective radiating surfaces and a leg projecting from the radiating surface;
a first feeding line and a second feeding line, each feeding line being associated with a respective one of the dipoles;
a support structure having a central recess, the support structure configured to support the dipole arms; and
a feeding line arrangement positioned within the central recess of the support structure and configured to support the two feeding lines, the feeding line arrangement comprises a plurality of snap-fit elements configured to form a snap-fit connection with the feeding lines.

16. The radiator assembly according to claim 15, wherein each feeding line includes two legs and a limb connecting the two legs, and wherein the plurality of snap-fit elements comprise a first snap-fit element configured to form a snap-fit connection with the limb of the first feeding line and a second snap-fit element configured to form a snap-fit connection with the limb of the second feeding line.

17. The radiator assembly according to claim 15, wherein the leg of each dipole arm is received by the central recess and rests against a respective inner wall of the central recess.

18. The radiator assembly according to claim 15, wherein the support structure includes four arm holders surrounding the central recess and a foot, the foot is configured to secure the support structure to a substrate or reflector of the base station antenna, and each arm holder is configured to support a respective dipole arm.

19. The radiator assembly according to claim 15, wherein each dipole arm is integrally formed of a sheet of metal, wherein the leg projects from the radiating surface at an angle with the radiating surface and is electrically grounded.

20. The radiator assembly according to claim 15, wherein each radiating surface is formed as a first conductive segment spaced-apart from a second conductive segment, the distal ends of the first and second conductive segments of each dipole arm being electrically connected to each other such that each dipole arm has a closed loop structure.
